(19) United States
(12) Patent Application Publication
(10) Pub. No.: US 2018/0052551 A1
(43) Pub. Date: Feb. 22, 2018

(54) SENSING DISPLAY PANEL

(71) Applicant: Industrial Technology Research Institute, Hsinchu (TW)

(72) Inventors: Chih-Chia Chang, Hsinchu County (TW); Kai-Ming Chang, New Taipei City (TW)

(73) Assignee: Industrial Technology Research Institute, Hsinchu (TW)

(21) Appl. No.: 15/584,048

(22) Filed: May 2, 2017

Related U.S. Application Data
(60) Provisional application No. 62/375,904, filed on Aug. 17, 2016.

(30) Foreign Application Priority Data
Feb. 20, 2017 (TW) 106105640

(51) Int. Cl. G06F 3/041; G06F 3/044

(52) U.S. Cl. CPC G06F 3/0412; G06F 3/044; G06F 2203/04112; G06F 2203/04103; G06F 2203/04111

(57) ABSTRACT

A sensing display panel comprises a display panel including a first substrate and a reflective layer disposed on the first substrate; a buffer layer having a first surface and a second surface opposite to the first surface; a sensing panel; and connection electrodes. The display panel is disposed on the first surface. The sensing display, including at least one filter layer, a gray film and a sensing device layer, has a sensing surface disposed on the second surface. The reflective layer reflects light from the sensing surface toward the sensing panel, the buffer layer, and the display panel. First and second conductive layers included in the sensing device layer are electrically insulated from each other. The first connection electrodes are disposed on the second surface or the first substrate, the first connection electrodes electrically connect to the first and the second conductive layers, respectively.

### CROSS-REFERENCE TO RELATED APPLICATION

This application claims the priority benefits of a U.S. provisional application Ser. No. 62/375,904, filed on Aug. 17, 2016 and a Taiwan application serial no. 106105640, filed on Feb. 20, 2017. The entirety of each of the above-mentioned patent applications is hereby incorporated by reference herein.

### TECHNICAL FIELD

The disclosure relates to a sensing display panel.

### BACKGROUND

A sensing display panel includes a display panel and a sensing panel. The sensing panel may be built in the display panel or attached onto the display panel. Based on different sensing types, sensing panels may be generally categorized into resistive sensing panels, capacitive sensing panels, optical sensing panels, acoustic-wave sensing panels and electromagnetic sensing panels. For instance, the resistive sensing panel and the capacitive sensing panel are designed to drive and sensed by two electrodes that are insulated from each other.

Generally, due to the reflective optical property of an electrode or a medium, ambient light may result in reflection on the appearance of a sensing display panel. Thus, the color quality of light beams with colors displayed on the sensing display panel may be affected. Currently, one of options for facilitating the color quality of the light beams with colors displayed on the sensing display panel includes eliminating the reflection of ambient light by attaching a polarizing film or a retardation film on a sensing surface of the sensing display panel.

### SUMMARY

A sensing display panel according to an embodiment of the present disclosure includes a display panel, a buffer layer, a sensing panel, and a plurality of first connection electrodes. The display panel includes a first substrate and a reflective layer-disposed on the first substrate. The buffer layer has a first surface and a second surface opposite to the first surface, wherein the display panel is disposed on the first surface. The sensing display has a sensing surface disposed on the second surface of the buffer layer. The sensing display includes at least one filter layer, a gray film, and a sensing device layer. The light transmitted from the sensing surface toward the sensing panel, the buffer layer, and the display panel is reflected by the reflective layer. The sensing device layer includes at least one first conductive layer and at least one second conductive layer, and the first and the second conductive layers are electrically insulated from each other. The plurality of first connection electrodes are disposed on the second surface of the buffer layer or the first substrate of the display panel, and the plurality of first connection electrodes electrically connect to the at least one first conductive layer and the at least one second conductive layer, respectively.

A sensing display panel according to another embodiment of the present disclosure includes a display panel, a buffer layer, and a sensing panel. The display panel includes a first substrate and a reflective layer disposed on the first substrate. The buffer layer has a first surface and a second surface opposite to the first surface, and the display panel is disposed on the first surface. The sensing display has a sensing surface disposed on the second surface of the buffer layer. The sensing display includes at least one filter layer and a sensing device layer. A light transmitted from the sensing surface toward the sensing panel, the buffer layer, and the display panel is reflected by the reflective layer. An optical density ratio between the buffer layer and the at least one filter layer with respect to visible light is N, and N is greater than 1 and less than or equal to 40.

Several exemplary embodiments accompanied with figures are described in detail below to further describe the disclosure in details.

### BRIEF DESCRIPTION OF THE DRAWINGS

FIG. 1 is a schematic cross-sectional view illustrating a sensing display panel according to a first embodiment of the disclosure.

FIG. 2A is a schematic top view illustrating a sensing display panel according to a second embodiment of the disclosure.

FIG. 2B is a schematic top view illustrating a sensing display panel according to an embodiment of the disclosure.

FIG. 2C is a schematic top view illustrating a sensing display panel according to another embodiment of the disclosure.

FIG. 2D is a schematic top view illustrating a sensing display panel according to another embodiment of the disclosure.

FIG. 3 is a schematic cross-sectional view illustrating a sensing panel of a sensing display panel according to a third embodiment of the disclosure.

FIG. 4 is a schematic cross-sectional view illustrating a sensing panel of a sensing display panel according to a fourth embodiment of the disclosure.

FIG. 5 is a schematic cross-sectional view illustrating a sensing panel of a sensing display panel according to a fifth embodiment of the disclosure.

FIG. 6 is a schematic bottom view illustrating a sensing panel of a sensing display panel according to a sixth embodiment of the disclosure.

FIG. 7 is a schematic cross-sectional view illustrating a sensing panel of a sensing display panel according to a seventh embodiment of the disclosure.

FIG. 8 is a schematic cross-sectional view illustrating a sensing panel of a sensing display panel according to an eighth embodiment of the disclosure.

FIG. 9 is a schematic cross-sectional view illustrating a sensing panel of a sensing display panel according to a ninth embodiment of the disclosure.

FIG. 10 is a schematic cross-sectional view illustrating a sensing panel of a sensing display panel according to a tenth embodiment of the disclosure.

FIG. 11 is a schematic cross-sectional view illustrating a sensing panel of a sensing display panel according to an eleventh embodiment of the disclosure.

FIG. 12 is a schematic cross-sectional view illustrating a sensing panel of a sensing display panel according to a twelfth embodiment of the disclosure.

FIG. 13 is a schematic cross-sectional view illustrating a sensing panel of a sensing display panel according to a thirteenth embodiment of the disclosure.

FIG. 14 is a schematic cross-sectional view illustrating a sensing panel of a sensing display panel according to a fourteenth embodiment of the disclosure.

FIG. 15A˜FIG. 15C are schematic cross-sectional views illustrating various arrangements of a color filter layer cooperated with the sensing display panel shown in FIG. 1, respectively, according to a fifteenth embodiment of the disclosure.

FIG. 16 is a schematic cross-sectional view illustrating a sensing panel of a sensing display panel according to a sixteenth embodiment of the disclosure.

FIG. 17 is a schematic cross-sectional view illustrating a sensing panel of a sensing display panel according to a seventeenth embodiment of the disclosure.

FIG. 18 is a schematic cross-sectional view illustrating a sensing panel of a sensing display panel according to an eighteenth embodiment of the disclosure.

FIG. 19 is a schematic cross-sectional view illustrating a sensing panel of a sensing display panel according to a nineteenth embodiment of the disclosure.

FIG. 20 is a schematic cross-sectional view illustrating a sensing panel of a sensing display panel according to a twentieth embodiment of the disclosure.

FIG. 21 is a schematic cross-sectional view illustrating a sensing panel of a sensing display panel according to a twenty-first embodiment of the disclosure.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

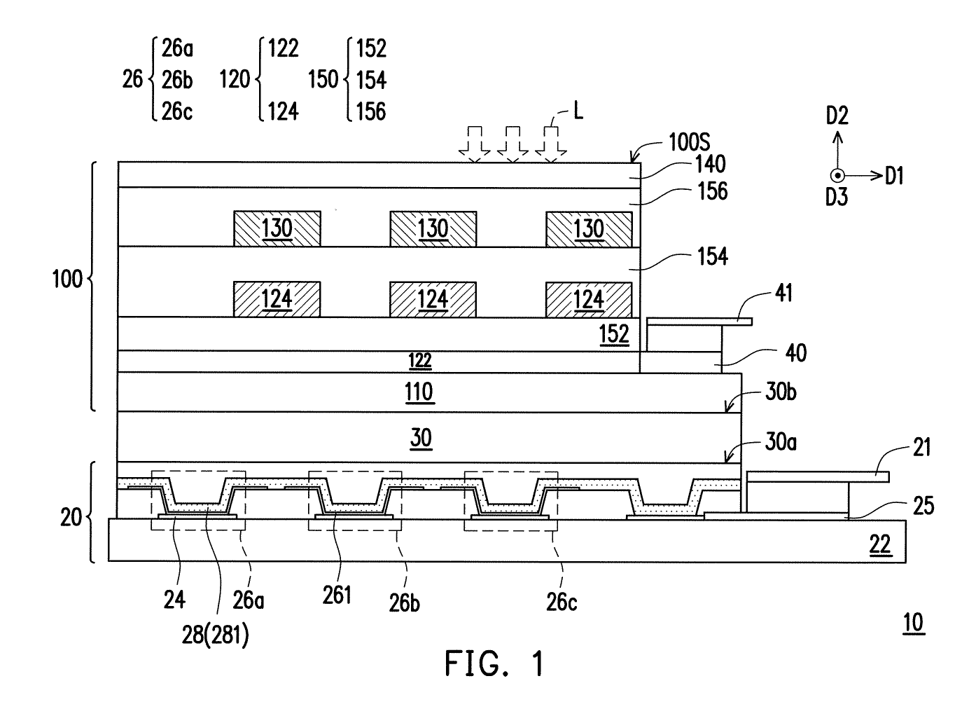

FIG. 1 is a schematic cross-sectional view illustrating a sensing display panel according to a first embodiment of the disclosure. In FIG. 1, the sensing display panel 10 of this embodiment may comprise a display panel 20, a buffer layer 30, a sensing panel 100, and a plurality of connection electrodes. The display panel 20 may have a light emitting region 26. The light emitting region 26 is located on a second substrate 22 and includes a plurality of first light emitting regions 26a, a plurality of second light emitting regions 26b, and a plurality of third light emitting regions 26c. In this embodiment, the first light emitting regions 26a, the second light emitting regions 26b, the third light emitting regions 26c respectively emit lights of different colors (for example, red light, blue light, and green light). Taking pixels of three primary colors as an example, a pixel at least includes a red sub-pixel having the first light emitting region 26a, at least one green sub-pixel having the second light emitting region 26b, and at least one blue sub-pixel having the third light emitting region 26c.

The display panel 20 may have a reflective layer 281. The reflective layer 281 may be a reflective conductive material or a transflective conductive material capable of reflecting light and used as an electrode in the display panel 20. In an embodiment, the reflective layer 281 may be a reflective film or a transflective film without the property of being electrically conductive. In other embodiments, the reflective layer 281 may also be formed by films stacked with each other, so as to reflect light by utilizing the difference in refractive index between films. In this embodiment, the reflective layer 281 may be provided as a second electrode 28 of the display panel 20 and distributed on the second substrate 22 comprehensively. A light emitting layer 261 is an organic light emitting material, for example. In addition, a first electrode 24, the light emitting layer 261, and the second electrode 28 may form a structure having a micro-cavity, for example, so as to improve the light emitting efficiency and the coherence of light in the light emitting region 26. In this embodiment, a material of the first electrode 24 may include indium tin oxide (ITO), and a material of the second electrode 28 may include a magnesium-silver alloy, for example. However, the scope of the disclosure is not limited thereto.

The buffer layer 30 has a first surface 30a and a second surface 30b opposite to the first surface 30a. Also, the display panel 20 is disposed on the first surface 30a, and sensing panel 100 is disposed on the second surface 30b of the buffer layer. In detailed, the buffer layer 30 is located between the display panel 20 and the sensing panel 100. In an embodiment, the buffer layer 30 may have an adhesive property to adhere the display panel 20 and the sensing panel 100 to form the sensing display panel 10.

The sensing panel 100 has a sensing surface 100S, and the sensing panel 100 may include a sensing device layer 120, at least one filter layer 130, and a gray film 140. Light transmitted from the sensing surface 100S toward the sensing panel 100, the buffer layer 30, and the display panel 20 may be reflected by the reflective layer 281. That is, after the light emitted by the light emitting region 26 of the display panel 20 passes through the sensing panel 100, the outside world may observe images generated by the display panel 20 through the sensing surface 100S of the sensing panel 100. Ambient light L may also enter the sensing panel 100 and the display panel 20 from the sensing surface 100S. The ambient light L entering the display panel 20 may be reflected by the reflective layer 281 in the display panel 20 and emitted from the sensing surface 100S of the sensing panel 100. The light emitted by the light emitting region 26 of the display panel 20, the ambient light L entering the display panel 20, and the ambient light L reflected by the reflective layer 281 of the display panel 20 may be absorbed by the gray film 140 and/or the filter layer 130 to reduce the reflected light of the ambient light L emitted from the sensing surface 100S. In an embodiment, an optical density ratio between the filter layer 130 and the gray film 140 with respect to visible light is N, and N is greater than 1 and less than or equal to 40. In other words, compared with the gray film 140, the filter layer 130 exhibits a higher light blocking effect, or the gray film 140 exhibits a higher light transmittance than that of the filter layer 130.

The sensing device layer 120 is configured to detect a signal which is generated when the user touches the sensing display panel 10. Such a signal may be a change of capacitance, a change of resistance, or the like. Taking capacitive sensing as an example, when the user touches the sensing display panel 10, the sensing device layer 120 may generate a change of capacitance in a touched region of the sensing device layer 120. The change of capacitance may be detected and identified by a controller (not shown) connected to the sensing device layer 120. In this embodiment, the sensing panel 100 may further include a dielectric layer 150, wherein the dielectric layer 150 includes a first dielectric layer 152, a second dielectric layer 154, and a third dielectric layer 156. The sensing device layer 120 includes at least one first conductive layer 122 and at least one second conductive layer 124 electrically insulated from each other, wherein the first dielectric layer 152 is located between the first conductive layer 122 and the second conductive layer 124, so that the first conductive layer 122 and the second conductive layer 124 are electrically insulated from each other. The second dielectric layer 154 is formed between the at least one second conductive layer 124 and the at least one filter layer 130, and is formed between the at least one second conductive layer 124. The second dielectric layer 154 may be configured to separate the at least one second conductive layer 124 from the at least one filter layer 130, and each of the at least one second conductive layer 124 is separated by the second dielectric layer 154. The third dielectric layer 156 is formed between the at least one filter layer 130 and the gray film 140, and is formed between the at least one filter layer 130. The third dielectric layer 156 may be configured to separate the at least one filter layer 130 from the gray fill 140, and the at least one filter layer 130 is separated from each other by the third dielectric layer 156. The first conductive layer 122 and the second conductive layer 124 have different extending directions (D1 and D3), respectively. In an embodiment, a ratio between the coverage area of the sensing device layer 120 in a direction D2 and the projected overlap area of the at least one filter layer 130 is greater than or equal to 70%, for example.

In an embodiment, the first dielectric layer 152, the second dielectric layer 154, or the third dielectric layer 156 may be made of inorganic materials. The inorganic materials may include SiOx, SiNx, SiON, AlOx, AlON, or other similar materials. In addition, the first dielectric layer 152, the second dielectric layer 154, or the third dielectric layer 156 may be made of organic materials. The organic materials may include polyimide (PI), polycarbonate (PC), polyamide (PA), polyethylene terephthalate (PET), polyethylene naphthalate (PEN), polyethylenimine (PEI), polyurethane (PU), polydimethylsiloxane (PDMS), an acrylic-based polymer (for example, polymethylmethacrylate, PMMA), an ether-based polymer (for example, polyethersulfone, PES or polyetheretherketone, PEEK), polyolefin, other similar materials, or a combination thereof. In other embodiments, the first dielectric layer 152, the second dielectric layer 154, or the third dielectric layer 156 may be formed by alternately stacking organic and inorganic layers, or formed of a hybrid material of organic and inorganic materials.

In this embodiment, the filter layers 130 may be located between the sensing device layer 120 and the gray film 140. The sub-pixels may be arranged as an array, and a pitch is maintained between any two adjacent pixels. The disposed positions of the at least one filter layer 130 may correspond to positions between the sub-pixels to avoid light leakage. Moreover, the at least one filter layers 130 of the sensing panel 100 may locally shield the light reflected by the reflective layer 281 of the display panel 20 to improve the display quality of the sensing display panel 10. Furthermore, the filter layers 130 of the sensing panel 100 may also locally shield the light entering the sensing panel 100 from the sensing surface 100S to improve the display quality of the sensing display panel 10. In an embodiment, the at least one filter layer 130 may be a black matrix (BM). For example, the black matrix may be manufactured by forming a BM material layer and then performing a patterning process on the BM material layer. A material of the black matrix may be, for example, a filter resin, and the patterned BM may be formed by performing a photolithography process. The material of the BM may also be chromium metal or other metals having a light absorbing property, and the patterned BM may be formed by performing a photolithography process and an etching process. In other embodiments, the at least one filter layer 130 may be a filter ink layer. For example, the BM may be formed by printing a polyester-based ink having a filter property.

In this embodiment, the gray film 140 may be distributed on the at least one filter layer 130 comprehensively, and the gray film 140 absorbs a part of the light. In more detailed, one part of the light emitted from the light emitting region 26 of the display panel 20 will be transmitted through the gray film 140, while another part of the emitted light will be absorbed by the gray film 140. A transmittance rate of the gray film 140 may be adjusted by changing a material or a thickness of the gray film 140. Moreover, the gray film 140 of the sensing panel 100 may absorb the light leaked of the sensing display panel 10, so as to reinforce the display quality of the sensing display panel 10. In an embodiment, the material of the gray film 140 may include metal, and the gray film 140 may be formed by a sputtering method or an evaporation method. In other embodiments, the gray film 140 may be formed by applying nanoparticles of metal or metal oxide and performing a sputtering method, an evaporation method, a coating method, or a sol-gel method. In an embodiment, the material of the gray film 140 includes a carbon-based material. The gray film 140 may be formed by encapsulating carbon powder, carbon-containing particles, or carbon black pigment with acrylic or other media. In other embodiments, the material of the gray film 140 includes a silicon-doped carbon-based material, and the gray film 140 may be formed by performing a chemical vapor deposition (CVD) process.

In this embodiment, the sensing panel 100 may further include a first substrate 110, and the sensing device layer 120, the filter layers 130, and the gray film 140 are disposed on the first substrate 110. The first substrate 110 may be a rigid or flexible substrate allowing transmittance of visible light. For example, a materials of the rigid substrate may include glass or other rigid materials, and materials of the flexible substrate may include polyethylene terephthalate (PET), polyimide (PI), polycarbonate (PC), polyamide (PA), polyethylene naphthalate (PEN), polyethylenimine (PEI), polyurethane (PU), polydimethylsiloxane (PDMS), an acrylic-based polymer (for example, polymethylmethacrylate, PMMA), an ether-based polymer (for example, polyethersulfone, PES or polyetheretherketone, PEEK), polyolefin, or other flexible materials. However, the scope of the disclosure is not limited thereto. The first substrate 110 may further include an inorganic particle, such as silica, alumina, zirconium oxide, vanadium oxide, chromium oxide, iron oxide, antimony oxide, tin oxide, titania, or a combination thereof.

In an embodiment, the dielectric layer 150 may have a flat surface to let devices formed subsequently be formed on the flat surface. In other embodiments, the dielectric layer 150 may serve to block permeation of oxygen and/or moisture. For instance, the rigid sensing display panel 10 may block the oxygen and/or moisture by the rigid substrate to prevent the damages of the sensing panel 100 or the display panel 20. However, a blocking ability of the flexible substrate made of the flexible material may not suffice to satisfy blocking requirements of the sensing panel 100 or the display panel 20 during the packaging process. Under such a circumstance, the dielectric layer 150 capable of blocking the permeation of oxygen and/or moisture, for example, may be used to prevent oxygen and/or moisture to affect the sensing panel 100 or the display panel 20. In addition to the dielectric layer 150, the gray film 140 may also have a blocking ability. Based on the needs, the dielectric layer 150 or the gray film 140 may be disposed between the layers described in the embodiments of the disclosure, respectively.

In this embodiment, the plurality of first connection electrodes 40 are disposed on and in contact with the first substrate 110. One end of each of the plurality of first connection electrodes 40 electrically connects to the first conductive layer 122 and the second conductive layer 124 of the sensing panel 100, respectively, and the other end of each of the plurality of first connection electrodes 40 may be subsequently bonded to a circuit board 41 (for example, a flexible circuit board, FPC). Further, the display panel 20 may further include a plurality of second connection electrodes 25 disposed on and in contact with the second substrate 22. One end of each of the plurality of second connection electrodes 25 respectively electrically connects to the first electrode 24 and the second electrode 28 of the display panel 20, and the other end of each of the plurality of second connection electrodes 25 may be subsequently bonded to a circuit board 21 (for example, a flexible circuit board, FPC), wherein the circuit boards 21 and 41 have the same bonding direction. In another embodiment, the first substrate 110 may be removed and the sensing panel 100 is formed on and in contact with the second surface 30b of the buffer layer 30. One end of each of the plurality of first connection electrodes 40 electrically connects to the first conductive layer 122 and the second conductive layer 124 of the sensing panel 100, respectively, and extends to the second substrate 22 of the display panel 20. The other end of each of the plurality of first connection electrodes 40 may be subsequently bonded to the circuit board 21 (for example, a flexible circuit board, FPC), that is, the plurality of first connection electrodes 40 and the plurality of second connection electrodes 25 may share the bonding area. Based on the needs, the method of respectively bonding the plurality of first connection electrodes 40 and the plurality of second connection electrodes 25 to the circuit boards 21, 41 may be cooperatively used in each of the embodiments of the disclosure.

In an embodiment, the hardness of the filter layer 130 or the gray film 140 may be higher than 1 H, for example, to provide an anti-scratch function. In addition, the sensing display panel 10 may further include a protection structure disposed on the sensing surface 100S. The material of the protection structure may be, but not limited to reinforced glass or quartz glass, and the hardness of the protection structure may be higher than 1 H, for example, to prevent abrasion or impact to the sensing panel 100.

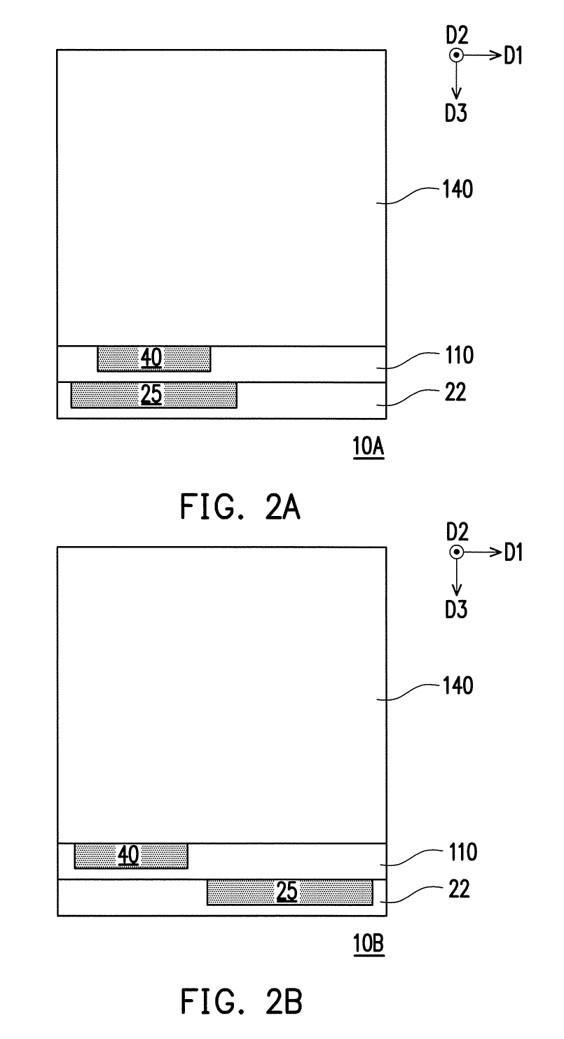

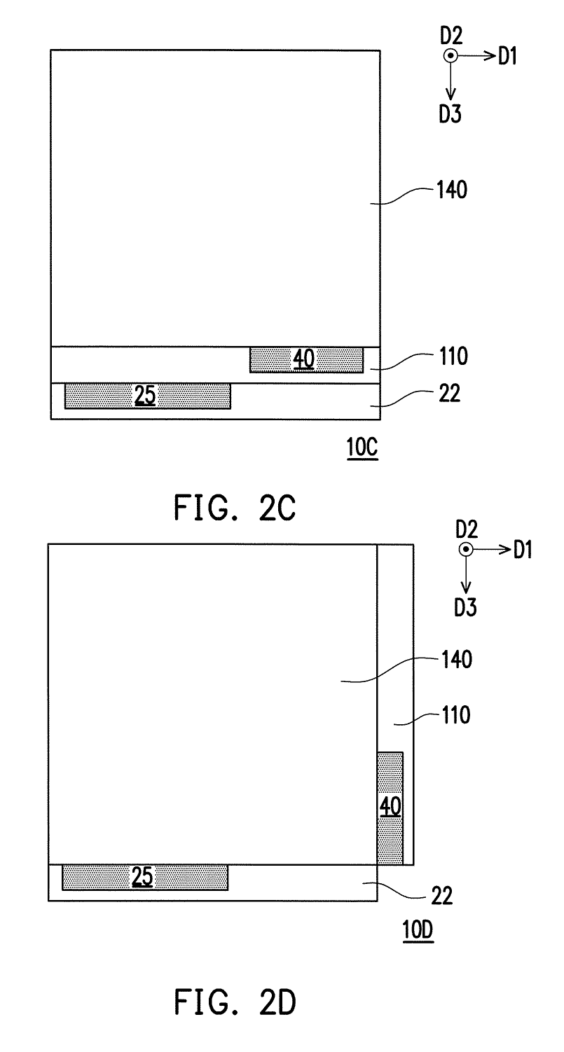

In embodiments of the disclosure, FIG. 2A˜FIG. 2D illustrate configurations of disposition for the plurality of first connection electrodes 40 and the plurality of second connection electrodes 25, respectively. FIG. 2A is a schematic top view illustrating a sensing display panel 10A according to a second embodiment of the disclosure. FIG. 2B is a schematic top view illustrating a sensing display panel 10B according to an embodiment of the disclosure. FIG. 2C is a schematic top view illustrating a sensing display panel 10C according to another embodiment of the disclosure. FIG. 2D is a schematic top view illustrating a sensing display panel 10D according to another embodiment of the disclosure. Referring to FIG. 2A, the plurality of first connection electrodes 40 and the plurality of second connection electrodes 25 may be disposed adjacently and on the same side of the sensing display panel 10A. In other embodiments, the plurality of first connection electrodes 40 and the plurality of second connection electrodes 25 may be interleaved and located on the same side of the sensing display panels 10B and 10C, as shown in FIGS. 2B and 2C. In an embodiment, the plurality of first connection electrodes 40 and the plurality of second connection electrodes 25 may be disposed on different sides of the sensing display panel 10D, respectively, as shown in FIG. 2D.

In the following, different embodiments are provided to describe the sensing display panel. For a detailed description of omitted parts, reference may be found in the previous embodiments, and no repeated description is contained in the following embodiments.

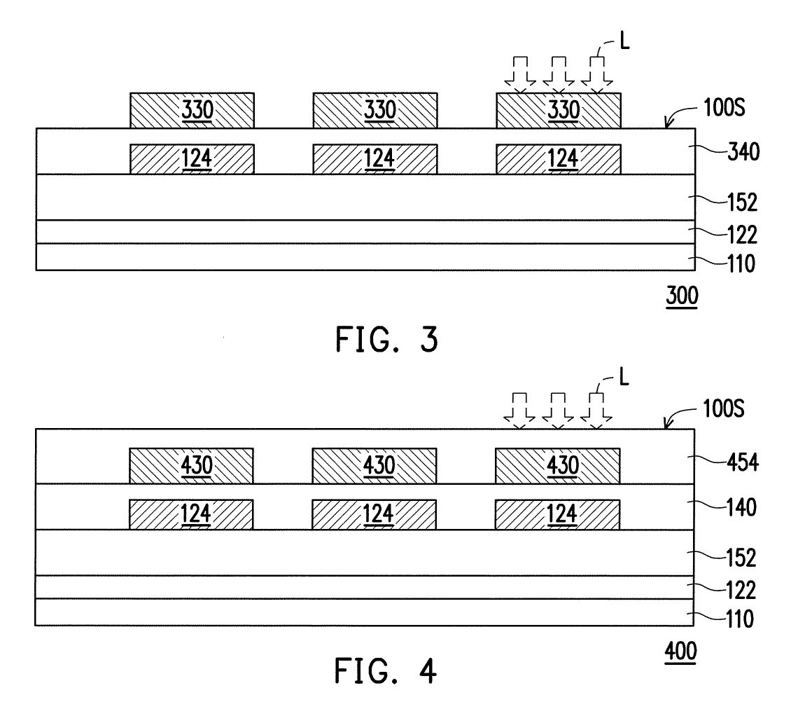

FIG. 3 is a schematic cross-sectional view illustrating a sensing panel 300 of a sensing display panel according to a third embodiment of the disclosure. In FIG. 3, like or similar reference numerals represent like or similar components. Thus, components already described in FIG. 1 will not be described in the following. In this embodiment, filter layers 330 of the sensing panel 300 are located on the sensing device layer 120. A gray film 340 is formed between the second conductive layers 124 and the filter layers 330, and between the second conductive layers 124. The gray film 340 may be configured to separate the second conductive layers 124 from the filter layers 330, and each of the second conductive layers 124 is separated by the gray film 340. The second conductive layers 124 and the filter layers 330 are separated from each other. In one embodiment, the hardness of the filter layer 330 or the gray film 340 may be higher than 1 H, for example, to provide an anti-scratch function.

FIG. 4 is a schematic cross-sectional view illustrating a sensing panel of a sensing display panel 400 according to a fourth embodiment of the disclosure. The sensing panel 400 of the fourth embodiment is similar to the sensing panel 300 of the third embodiment. In FIG. 4, like or similar reference numerals represent like or similar components. Thus, components already described in FIG. 3 will not be described in the following. In this embodiment, the sensing panel 400 includes a second dielectric layer 454, wherein the second dielectric layer 454 covers filter layers 430 and separates the filter layers 430 from each other. In one embodiment, a hardness of the second dielectric layer 454 may be, for example, higher than 1 H to provide an anti-scratch function.

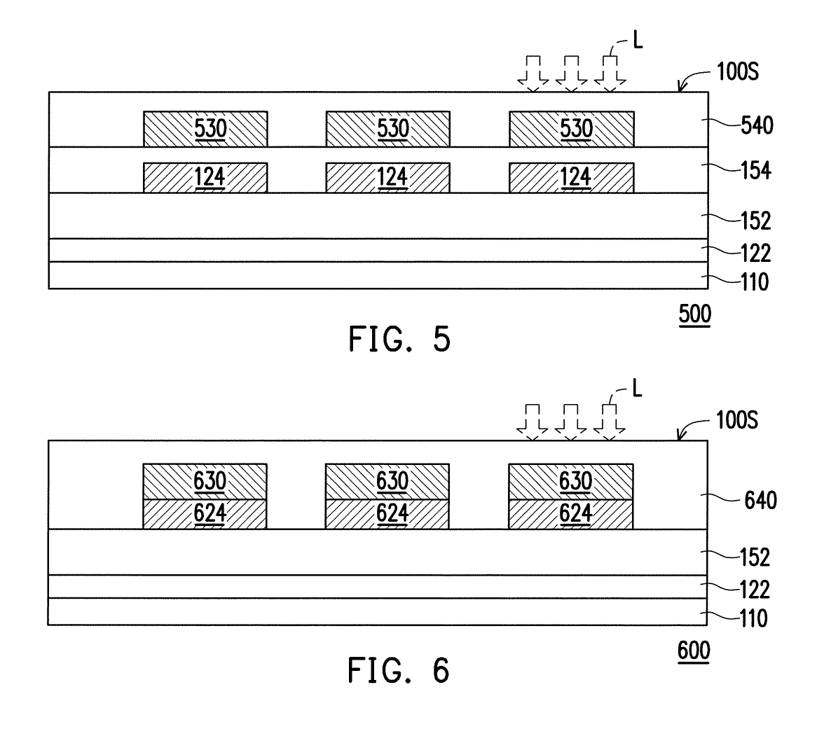

FIG. 5 is a schematic cross-sectional view illustrating a sensing panel of a sensing display panel 500 according to a fifth embodiment of the disclosure. The sensing panel 500 of the fifth embodiment is similar to the sensing panel 100 of the first embodiment. In FIG. 5, like or similar reference numerals represent like or similar components. Thus, components already described in FIG. 1 will not be described in the following. In this embodiment, a gray film 540 of the sensing panel 500 covers filter layers 530 and separates the filter layers 530 from each other, and the filter layers 530 are located between the sensing device layer 120 and the gray film 540. In one embodiment, a hardness of the gray film 540 may be, for example, higher than 1 H to provide an anti-scratch function.

FIG. 6 is a schematic bottom view illustrating a sensing panel of a sensing display panel 600 according to a sixth embodiment of the disclosure. In FIG. 6, like or similar reference numerals represent like or similar components. Thus, components already described in FIG. 1 will not be described in the following. In this embodiment, filter layers 630 of the sensing panel 600 are located on and in contact with corresponding second conductive layers 624, respectively. A gray film 640 covers each pair of one of the filter layers 630 and one of the corresponding second conductive layers 624, which may be configured to separate pairs of the filter layers 630 and the corresponding second conductive layers 624 from each other. In one embodiment, a hardness of the gray film 640 may be higher than 1 H, for example, to provide an anti-scratch function.

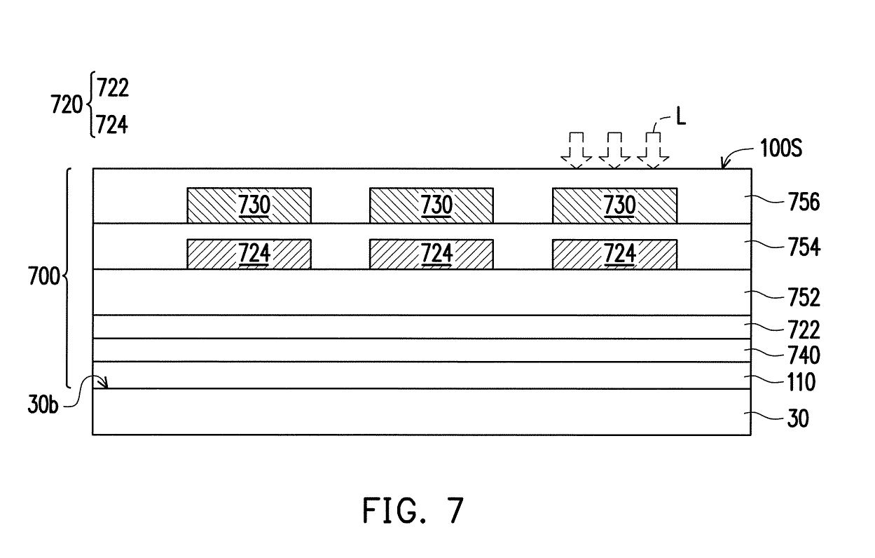

FIG. 7 is a schematic cross-sectional view illustrating a sensing panel of a sensing display panel 700 according to a seventh embodiment of the disclosure. In FIG. 7, like or similar reference numerals represent like or similar components. Thus, components already described in FIG. 1 will not be described in the following. In this embodiment, a sensing device layer 720 of the sensing panel 700 is located between a gray film 740 and filter layers 730, wherein the gray film 740 is adjacent to one side of the first substrate 110 or the buffer layer 30. The first dielectric layer 752 is provided between first conductive layers 722 and second conductive layers 724, so that the first conductive layers 722 and the second conductive layers 724 are electrically insulated from each other. Further, a second dielectric layer 754 is formed between the second conductive layers 724 and the filter layers 730, and between the second conductive layers 724; the second dielectric layer 754 may be configured to separate the second conductive layers 724 from the filter layers 730, and separate the second conductive layers 724 from each other. The third dielectric layer 756 may be configured to cover the filter layers 730, and separate the filter layers 730 from each other. The first conductive layers 722 and the second conductive layers 724 have different extension directions (D1 and D3).

In an embodiment, the gray film 740 may be located between the first substrate 110 and the buffer layer 30. In another embodiment, the first substrate 110 may further include nanoparticles of metal or metal oxide, or carbon-based materials such as carbon powder, carbon-containing particles, or carbon black pigment, so that the first substrate 110 may absorb a part of the light and be provided as the gray film 740. In other embodiments, a hardness of the third dielectric layer 756 may be higher than 1 H, for example, to provide an anti-scratch function. In another embodiment, the first substrate 110 may be removed to reduce the thickness of the sensing panel 700. The sensing panel 700 is formed on and in contact with the second surface 30b of the buffer layer 30; the gray film 740 may be located between the sensing device layer 720 and the buffer layer 30.

In other embodiments, the gray film 740 may be located between the sensing device layer 720 and the filter layers 730. In one embodiment, the gray film 740 may be formed between the first conductive layers 722 and the second conductive layers 724, and between the first conductive layers 722, and the gray film 740 may be formed to separate the first conductive layers 722 from the second conductive layers 724, and separate the first conductive layers 722 from each other.

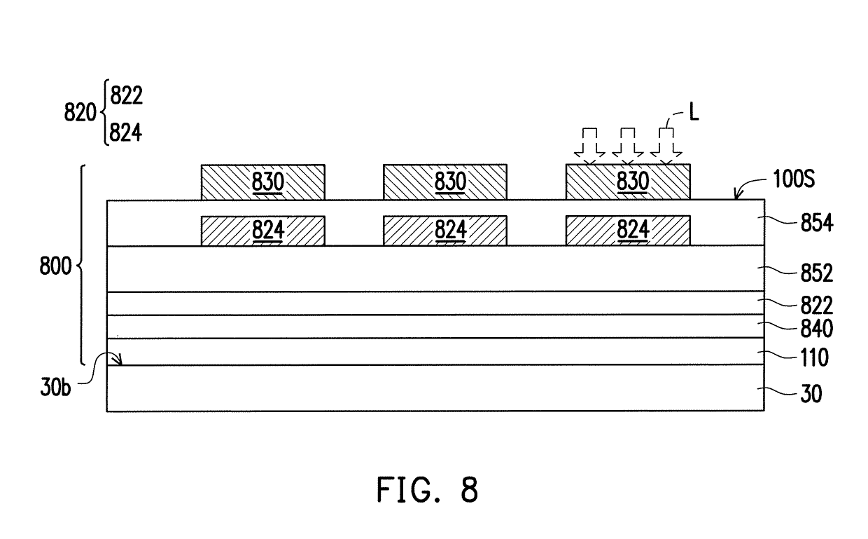

FIG. 8 is a schematic cross-sectional view illustrating a sensing panel of a sensing display panel 800 according to an eighth embodiment of the disclosure. The sensing panel 800 of the eighth embodiment is similar to the sensing panel 700 of the seventh embodiment. In FIG. 8, like or similar reference numerals represent like or similar components. Thus, components already described in FIG. 7 will not be described in the following. In this eighth embodiment, filter layers 830 of the sensing panel 800 are disposed on a sensing device layer 820. A gray film 840 is adjacent to one side of the first substrate 110 or the buffer layer 30. A first dielectric layer 852 is provided between first conductive layers 822 and second conductive layers 824, so that the first conductive layers 822 and the second conductive layers 824 are electrically insulated from each other. Further, the second dielectric layer 854 is formed between the second conductive layers 824 and the filter layers 830, and between the second conductive layers 824; the second dielectric layer 854 may be configured to separate the second conductive layers 824 from the filter layers 830, and separate the second conductive layers 824 from each other. The first conductive layers 822 and the second conductive layer 824 have different extension directions (D1 and D3).

In an embodiment, the gray film 840 may be located between the first substrate 110 and the buffer layer 30. In another embodiment, the first substrate 110 may further include nanoparticles of metal or metal oxide, or carbon-based materials such as carbon powder, carbon-containing particles, or carbon black pigment, so that the first substrate 110 may absorb a part of the light and be provided as a gray film 840. In other embodiments, a hardness of the second dielectric layer 854 may be, for example, higher than 1 H to provide an anti-scratch function. In another embodiment, the first substrate 110 may be removed to reduce the thickness of the sensing panel 800. The sensing panel 800 is formed on and in contact with the second surface 30b of the buffer layer 30; the gray film 840 may be located between the sensing device layer 820 and the buffer layer 30. In other embodiments, the gray film 840 may be located between the sensing device layer 820 and the filter layers 830.

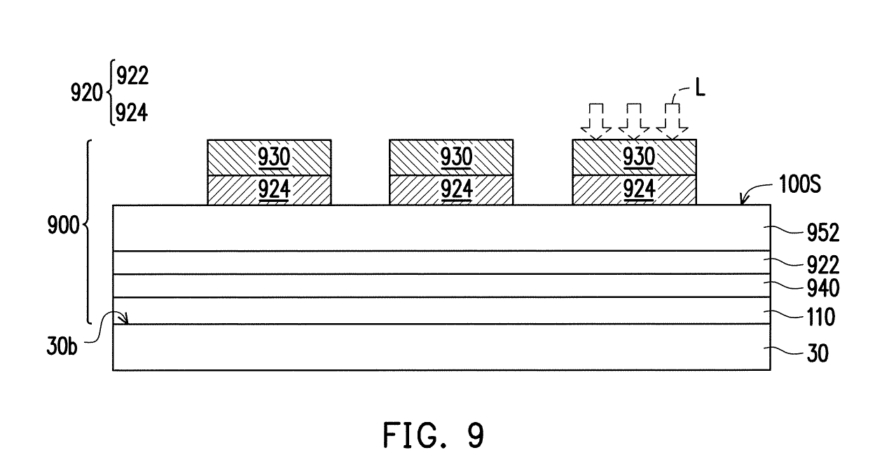

FIG. 9 is a schematic cross-sectional view illustrating a sensing panel of a sensing display panel 900 according to a ninth embodiment of the disclosure. In FIG. 9, like or similar reference numerals represent like or similar components. Thus, components already described in FIG. 6 will not be described in the following. In this ninth embodiment, the filter layers 930 of the sensing panel 900 are disposed on and in contact with the second conductive layers 924, wherein the gray film 940 is adjacent to one side of the first substrate 110 or the buffer layer 30. The first dielectric layer 952 is provided between first conductive layers 922 and the second conductive layers 924, and between the first conductive layers 922; the first dielectric layer 952 may be configured to separate the first conductive layers 922 and the second conductive layers 924, and separate the first conductive layers 922 from each other. The first conductive layers 922 and the second conductive layers 924 have different extension directions (D1 and D3).

In an embodiment, the gray film 940 may be located between the first substrate 110 and the buffer layer 30. In another embodiment, the first substrate 110 may further include nanoparticles of metal or metal oxide, or carbon-based materials such as carbon powder, carbon-containing particles, or carbon black pigment, so that the first substrate 110 may absorb a part of the light and be provided as a gray film 940. In other embodiments, a hardness of the first dielectric layer 952 may be, for example, higher than 1 H to provide an anti-scratch function. In another embodiment, the first substrate 110 may be removed to reduce the thickness of the sensing panel 900. The sensing panel 900 is foil led on and in contact with the second surface 30b of the buffer layer 30; the gray film 940 may be located between the sensing device layer 920 and the buffer layer 30. In one embodiment, the gray film 940 may be formed between the first conductive layers 922 and the second conductive layers 924, and between the first conductive layers 922, and the gray film 940 may be configured to separate the first conductive layers 922 and the second conductive layers 924, and separate the first conductive layers 922 from each other.

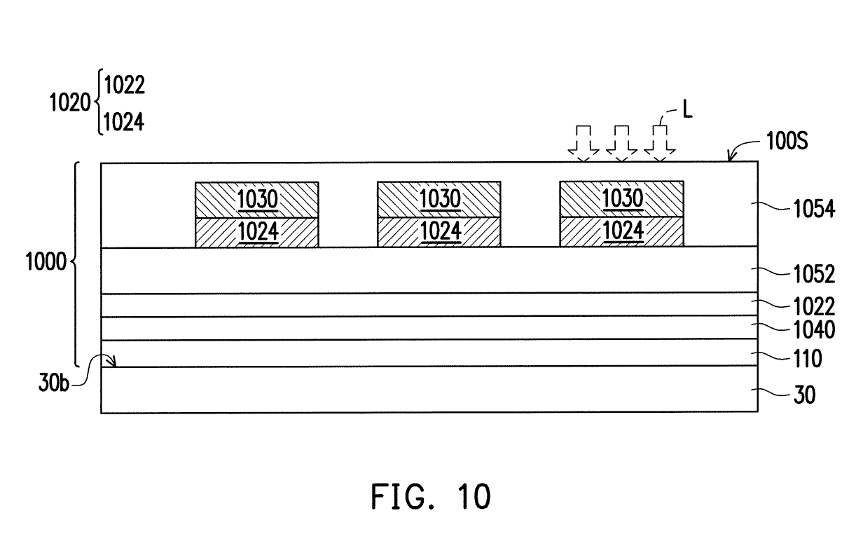

FIG. 10 is a schematic cross-sectional view illustrating a sensing panel of a sensing display panel 1000 according to a tenth embodiment of the disclosure. In FIG. 10, like or similar reference numerals represent like or similar components. Thus, components already described in FIG. 6 will not be described in the following. In this embodiment, filter layers 1030 of the sensing panel 1000 are disposed on and in contact with corresponding second conductive layers 1024, wherein a gray film 1040 is adjacent to one side of the first substrate 110 or the buffer layer 30. A second dielectric layer 1054 is provided to cover each pair of one of the filter layers 1030 and one of the corresponding second conductive layers 1024. The second dielectric layer 1054 may be configured to separate pairs of the filter layers 1030 and the corresponding second conductive layers 1024 from each other. A first dielectric layer 1052 is between the first conductive layers 1022 and the second conductive layers 1024, and between first conductive layers 1022. The first dielectric layer 1052 may be configured to separate the first conductive layers 1022 from the second conductive layers 1024, and separate the first conductive layers 1022 from each other. The first conductive layers 1022 and the second conductive layers 1024 have different extension directions (D1 and D3).

In an embodiment, the gray film 1040 may be located between the first substrate 110 and the buffer layer 30. In another embodiment, the first substrate 110 may further include nanoparticles of metal or metal oxide, or carbon-based materials such as carbon powder, carbon-containing particles, or carbon black pigment, so that the first substrate 110 may absorb a part of the light and be provided as the gray film 1040. In other embodiments, a hardness of the second dielectric layer 1054 may be, for example, higher than 1 H to provide an anti-scratch function. In another embodiment, the first substrate 110 may be removed to reduce the thickness of the sensing panel 1000. The sensing panel 1000 is formed on and in contact with the second surface 30b of the buffer layer 30; the gray film 1040 may be located between the sensing device layer 1020 and the buffer layer 30. In other embodiment, the gray film 1040 may be formed between the first conductive layers 1022 and the second conductive layers 1024, and between the first conductive layers 1022. The gray film 1040 may be configured to separate the first conductive layers 1022 and the second conductive layers 1024, and separate the first conductive layers 1022 from each other. In one embodiment, the gray film 1040 may be located on the second dielectric layer 1054, wherein a hardness of the gray film 1040 may be, for example, higher than 1 H to provide an anti-scratch function.

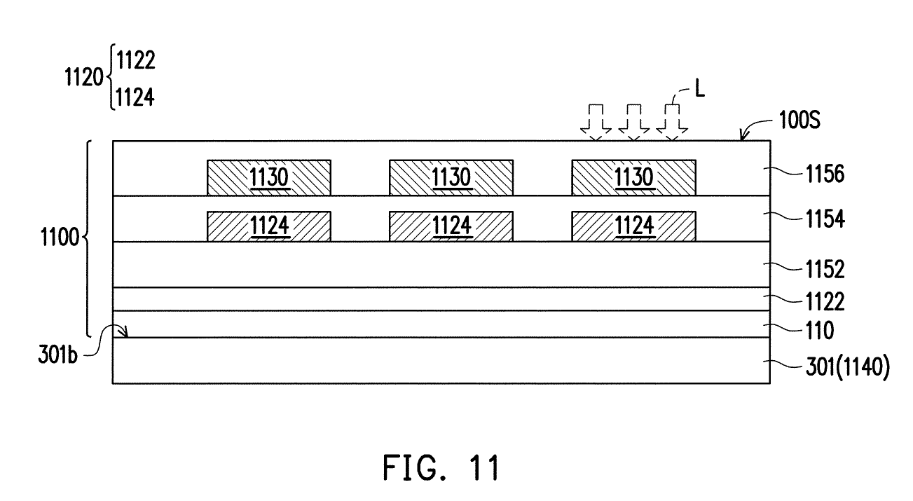

FIG. 11 is a schematic cross-sectional view illustrating a sensing panel of a sensing display panel 1100 according to an eleventh embodiment of the disclosure. In FIG. 11, like or similar reference numerals represent like or similar components. Thus, components already described in FIG. 7 will not be described in the following. In this eleventh embodiment, a buffer layer 301 of the sensing panel 1100 may further include nanoparticles of metal or metal oxide, or carbon-based materials such as carbon powder, carbon-containing particles, or carbon black pigment, so that the buffer layer 301 may absorb a part of the light and be provided as a gray film 1140. In an embodiment, an optical density ratio between the buffer layer 301 and the at least one filter layer 1130 with respect to visible light is N, and N may be greater than 1 and less than or equal to 40. The sensing device layer 1120 is located between the first substrate 110 and filter layers 1130. A first dielectric layer 1152 is provided between first conductive layers 1122 and second conductive layers 1124, so that the first conductive layers 1122 and the second conductive layers 1124 are electrically insulated from each other. Further, a second dielectric layer 1154 is formed between the second conductive layers 1124 and the filter layers 1130, and between the second conductive layers 1124; the second dielectric layer 1154 may be configured to separate the second conductive layers 1124 from the filter layers 1130, and separate the second conductive layers 1124 from each other. A third dielectric layer 1156 is formed on the filter layers 1130 and between the filter layers 1130, and the third dielectric layer 1156 may be configured to separate the filter layers 1130 from each other. The first conductive layers 1122 and the second conductive layers 1124 have different extension directions (D1 and D3). In one embodiment, a hardness of the third dielectric layer 1156 may be, for example, higher than 1 H to provide an anti-scratch function. In another embodiment, the first substrate 110 may be removed to reduce the thickness of the sensing panel 1100. The sensing panel 1100 is formed on and in contact with a second surface 301b of the buffer layer 301.

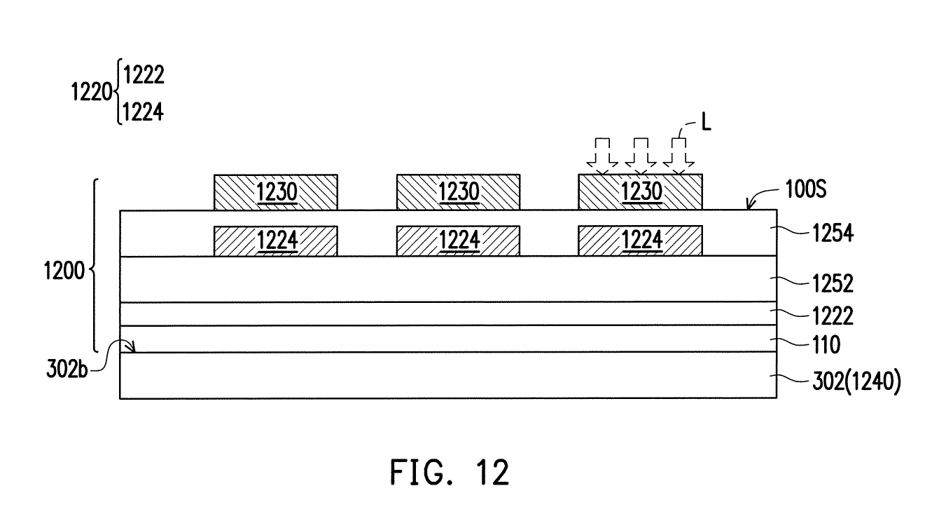

FIG. 12 is a schematic cross-sectional view illustrating a sensing panel 1200 according to a twelfth embodiment of the disclosure. In FIG. 12, like or similar reference numerals represent like or similar components. Thus, components already described in FIG. 8 will not be described in the following. In this twelfth embodiment, a buffer layer 302 of the sensing panel 1200 may further include nanoparticles of metal or metal oxide, or carbon-based materials such as carbon powder, carbon-containing particles, or carbon black pigment, so that the buffer layer 302 may absorb a part of the light and be provided as a gray film 1240. In an embodiment, an optical density ratio between the buffer layer 302 and the at least one filter layer 1230 with respect to visible light is N, and N may be greater than 1 and less than or equal to 40. The sensing device layer 1220 is located between the first substrate 110 and the filter layer 1230. The first dielectric layer 1252 is provided between first conductive layers 1222 and second conductive layers 1224, so that the first conductive layers 1222 and the second conductive layers 1224 are electrically insulated from each other. Further, a second dielectric layer 1254 is formed between the second conductive layers 1224 and the filter layers 1230, and between the second conductive layers 1224; the second dielectric layer 1254 may be configured to separate the second conductive layer 1224 from the filter layers 1230, and separate the second conductive layers 1224 from each other. The first conductive layers 1222 and the second conductive layers 1224 have different extension directions (D1 and D3). In one embodiment, a hardness of the second dielectric layer 1254 may be, for example, higher than 1 H to provide an anti-scratch function. In another embodiment, the first substrate 110 may be removed to reduce the thickness of the sensing panel 1200. The sensing panel 1200 is formed on and in contact with a second surface 302b of the buffer layer 302.

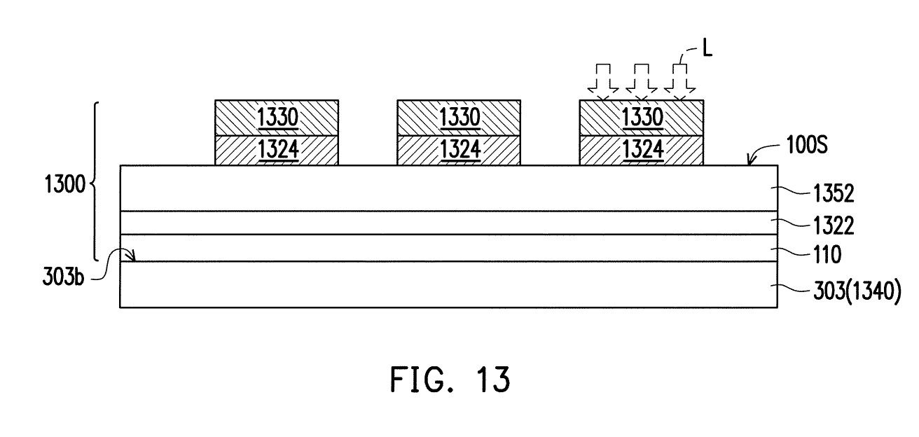

FIG. 13 is a schematic cross-sectional view illustrating a sensing panel 1300 according to a thirteenth embodiment of the disclosure. In FIG. 13, like or similar reference numerals represent like or similar components. Thus, components already described in FIG. 9 will not be described in the following. In this thirteenth embodiment, a buffer layer 303 of the sensing panel 1300 may further include nanoparticles of metal or metal oxide, or carbon-based materials such as carbon powder, carbon-containing particles, or carbon black pigment, so that the buffer layer 303 may absorb a part of the light and be provided as a gray film 1340. In an embodiment, an optical density ratio between the buffer layer 303 and the at least one filter layer 1330 with respect to visible light is N, and N may be greater than 1 and less than or equal to 40. Filter layers 1330 are located on and in contact with second conductive layers 1324. A first dielectric layer 1352 is provided between first conductive layers 1322 and second conductive layers 1324, and between the first conductive layers 1322; the first dielectric layer 1352 may be configured to separate the first conductive layers 1322 from the second conductive layers 1324, and separate the first conductive layers 1322 from each other. The first conductive layers 1322 and the second conductive layers 1324 have different extension directions (D1 and D3). In one embodiment, a hardness of the first dielectric layer 1352 may be, for example, higher than 1 H to provide an anti-scratch function. In another embodiment, the first substrate 110 may be removed to reduce the thickness of the sensing panel 1300. The sensing panel 1300 is formed on and in contact with a second surface 303b of the buffer layer 303.

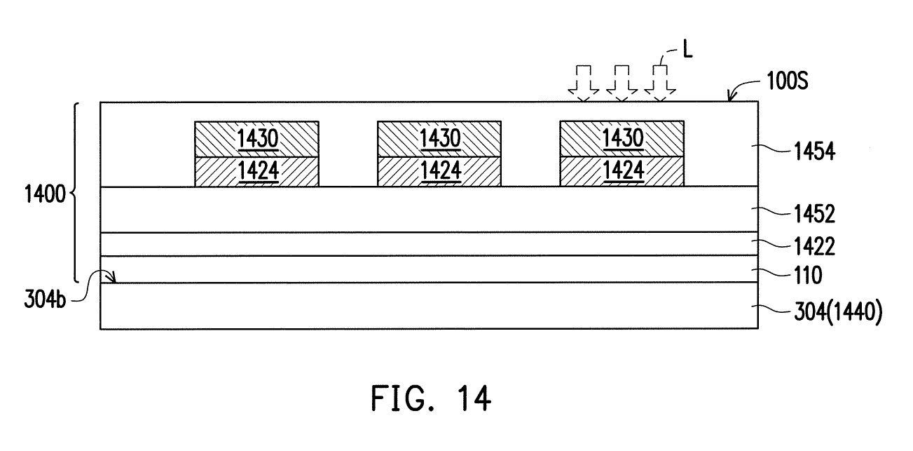

FIG. 14 is a schematic cross-sectional view illustrating a sensing panel 1400 according to a fourteenth embodiment of the disclosure. In FIG. 14, like or similar reference numerals represent like or similar components. Thus, components already described in FIG. 10 will not be described in the following. In this fourteenth embodiment, a buffer layer 304 of the sensing panel 1400 may further include nanoparticles of metal or metal oxide, or carbon-based materials such as carbon powder, carbon-containing particles, or carbon black pigment, so that the buffer layer 304 may absorb a part of the light and be provided as a gray film 1440. Filter layers 1430 are located on and in contact with corresponding second conductive layers 1424. A second dielectric layer 1454 is provided between the filter layers 1430 and the corresponding second conductive layers 1424, and the second dielectric layer 1454 may be configured to cover each pair of one of the filter layers 1430 and one of the corresponding second conductive layers 1424. A first dielectric layer 1452 is provided between first conductive layers 1422 and the second conductive layers 1424, and between the first conductive layers 1422; the first dielectric layer 1452 may be configured to separate the first conductive layers 1422 from the second conductive layers 1424, and separate the first conductive layers 1422 from each other. The first conductive layers 1422 and the second conductive layers 1424 have different extension directions (D1 and D3). In one embodiment, a hardness of the second dielectric layer 1454 may be, for example, higher than 1 H to provide an anti-scratch function. In another embodiment, the first substrate 110 may be removed to reduce the thickness of the sensing panel 1400. The sensing panel 1400 is formed on and in contact with a second surface 304b of the buffer layer 304.

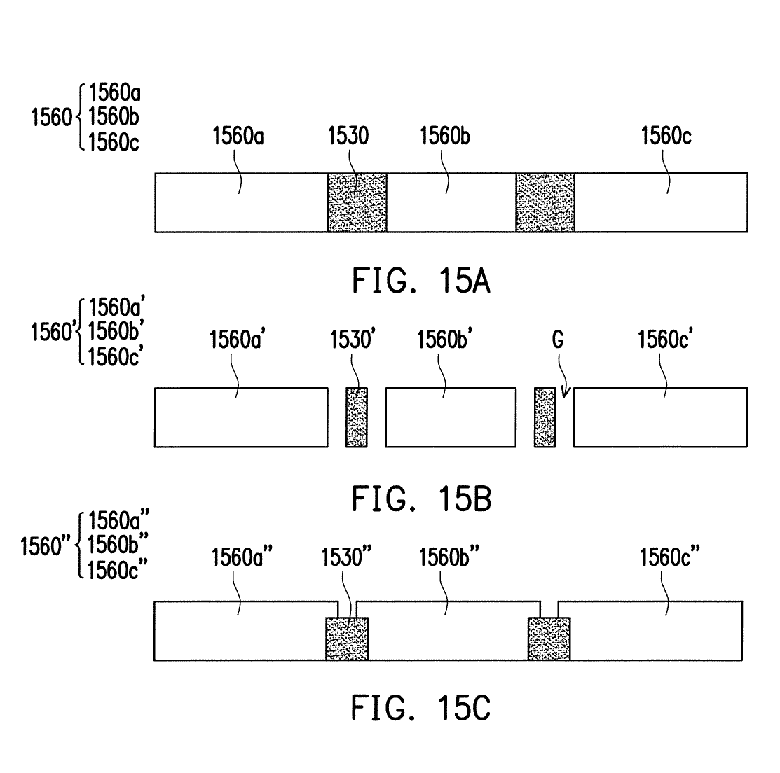

FIG. 15A˜FIG. 15C are schematic cross-sectional views illustrating various arrangements of a color filter layer cooperated with the sensing display panel 10 shown in FIG. 1, respectively, according to a fifteenth embodiment of the disclosure. Wherein, FIG. 15A is a schematic cross-sectional view illustrating an exemplary arrangement of the color filter layer cooperated with the sensing display panel 10. FIG. 15B is a schematic cross-sectional view illustrating another exemplary arrangement of the color filter layer cooperated with the sensing display panel 10. FIG. 15C is a schematic cross-sectional view illustrating yet another exemplary arrangement of the color filter layer cooperated with the sensing display panel 10. Take an arrangement shown in FIG. 15A as an example. Color filter layers may be disposed between filter layers 1530, respectively, wherein a color filter layer 1560 may include a first color filter layer 1560a, a second color filter layer 1560b, and a third color filter layer 1560c, to allow light with different colors (for example, red light, blue light, or green light) to pass through. Take a common arrangement as an example. Each color filter layer 1560 on the sensing panel 100 may shield light that is not emitted by the corresponding light emitting region 26 on the display panel 20 and reduce the reflection of ambient light, so as to reduce the light leakage of the sensing display panel 10. In addition, the light emitted by the light emitting region 26 after passing through the color filter layer 1560 may increase the color saturation to reinforce the display quality of the sensing display panel 10. Based on needs, the color filter layer 1560 may be disposed in other embodiments of the disclosure.

In an embodiment, the color filter layer 1560 may be formed by a way of inkjet printing. The forming process includes, for example, forming the filter layers 1530 with a plurality of openings on a substrate, injecting color inks (for example, red, green, or blue inks) into the openings of the filter layers 1530 by inkjet printing, and then performing a thermal baking process or a photo-curing process to cure the color inks, thereby forming the color filter layer 1560. The color inks are, for example, pigments, dyes or a combination thereof.

As shown in FIG. 15A, the color filter layer 1560 may be aligned with the edges of the filter layers 1530. In another embodiment, the color filter layer 1560 may be not aligned with the edges of the filter layers 1530. Referring to FIGS. 15B and 15C, only some of the layers are illustrated in FIGS. 15B and 15C for clarity of illustration. As shown in FIG. 15B, there is a color filter layer 1560′ disposed between filter layers 1530′, and there is a gap G provided between the color filter layer 1560′ and the filter layer 1530′. As shown in FIG. 15C, there is a color filter layer 1560″ provided between filter layers 1530″, and the color filter layer 1560″ and the adjacent filter layers 1530″ may be partially overlapped.

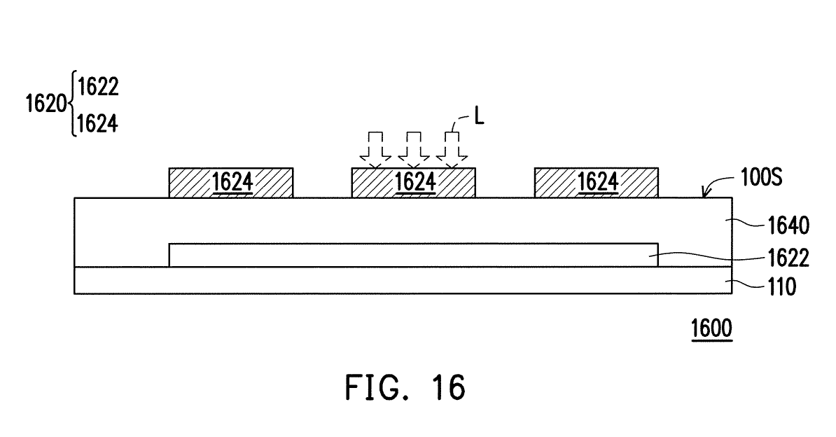

FIG. 16 is a schematic cross-sectional view illustrating a sensing panel 1600 according to a sixteenth embodiment of the disclosure, only some of the layers are illustrated in FIG. 16 for clarity of illustration. In FIG. 16, like or similar reference numerals represent like or similar components. Thus, components already described in FIG. 1 will not be described in the following. In this sixteenth embodiment, a sensing device layer 1620 includes at least one first filter conductive layer 1622 and at least one second filter conductive layer 1624, and the first and the second filter conductive layers are insulated from each other. The at least one first filter conductive layer 1622 and the at least one second filter conductive layer 1624 of the sensing panel 1600 may correspond to positions between the sub-pixels of the display panel 20 to avoid light leakage. In addition, the at least one first filter conductive layer 1622 and the at least one second filter conductive layer 1624 of the sensing panel 1600 may locally shield the light reflected by the reflective layer 281 of the display panel 20, so as to enhance the display quality of the sensing display panel 10. In the embodiment, the at least one first filter conductive layer 1622 and the at least one second filter conductive layer 1624 are conductive, thus in addition to receiving light, these filter conductive layers 1622 and 1624 may further transmit an electronic signal for being adapted to sense an electrical change generated by the user's touch. Furthermore, an ambient light L entering the sensing panel 1600 from the sensing surface 100S becomes a transmitted light and does not generate reflection from irradiation to the sensing device layers 1620. Thus, the images displayed by the display panel 20 and observed from outside through the sensing surface 100S of the sensing panel 1600 are not affected. Consequently, the display quality of the sensing display panel 10 may be reinforced.

In the embodiment, a gray film 1640 is located between the at least one first filter conductive layer 1622 and the at least one second filter conductive layer 1624. The at least one first filter conductive layer 1622 and the at least one second filter conductive layer 1624 are electrically insulated from each other by the gray film 1640. In an embodiment, a hardness of the gray film 1640 may be, for example, higher than 1 H to provide an anti-scratch function.

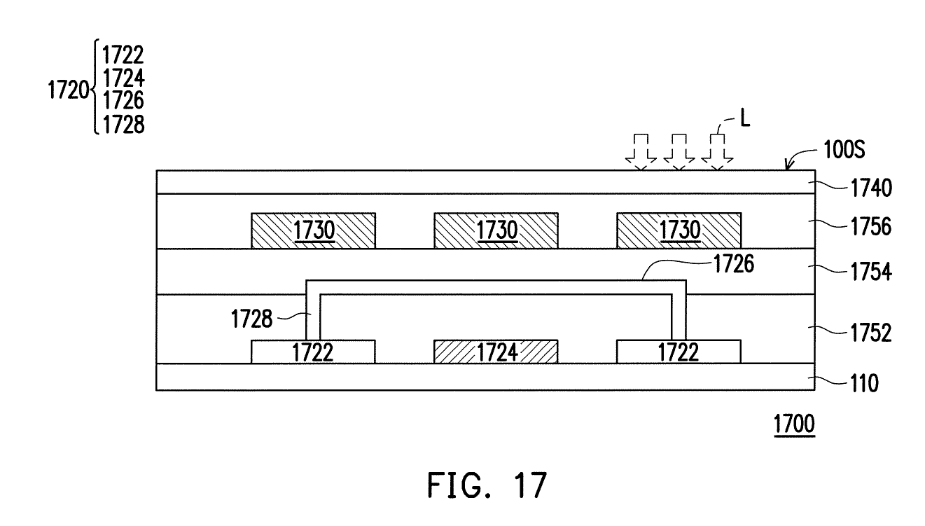

FIG. 17 is a schematic cross-sectional view illustrating a sensing panel 1700 according to a seventeenth embodiment of the disclosure. In FIG. 17, like or similar reference numerals represent like or similar components. Thus, components already described in FIG. 1 will not be described in the following. In this seventeenth embodiment, the sensing device layer 1720 further includes at least one sensing bridge 1726 and a plurality of conductive vias 1728. The conductive vias 1728 penetrate through a first dielectric layer 1752, and the first dielectric layer 1752 is located between the sensing bridge 1726, the at least one first conductive layer 1722 and the at least one second conductive layer 1724. In an embodiment, vias are formed in the first dielectric layer 1752 by etching, grind-drilling, laser drilling, or other suitable processes. Then, a conductive material is filled into the vias to form the conductive vias 1728 in the first dielectric layer 1752. Each of the at least one first conductive layer 1722 may connect to one of the sensing bridge 1726 on the first dielectric layer 1752 through one corresponding conductive via 1728. In one embodiment, the sensing panel 1700 may have a buffer layer (not shown) on the other side of the first substrate 110 with respect to the sensing device layer 1720. The buffer layer may further include nanoparticles of metal or metal oxide, or carbon-based materials such as carbon powder, carbon-containing particles, or carbon black pigment, so that the buffer layer may absorb a part of the light and be provided as the gray film 1740. In an embodiment, an optical density ratio between the filter layer 1730 and the gray film 1740 with respect to visible light is N, and N may be greater than 1 and less than or equal to 40.

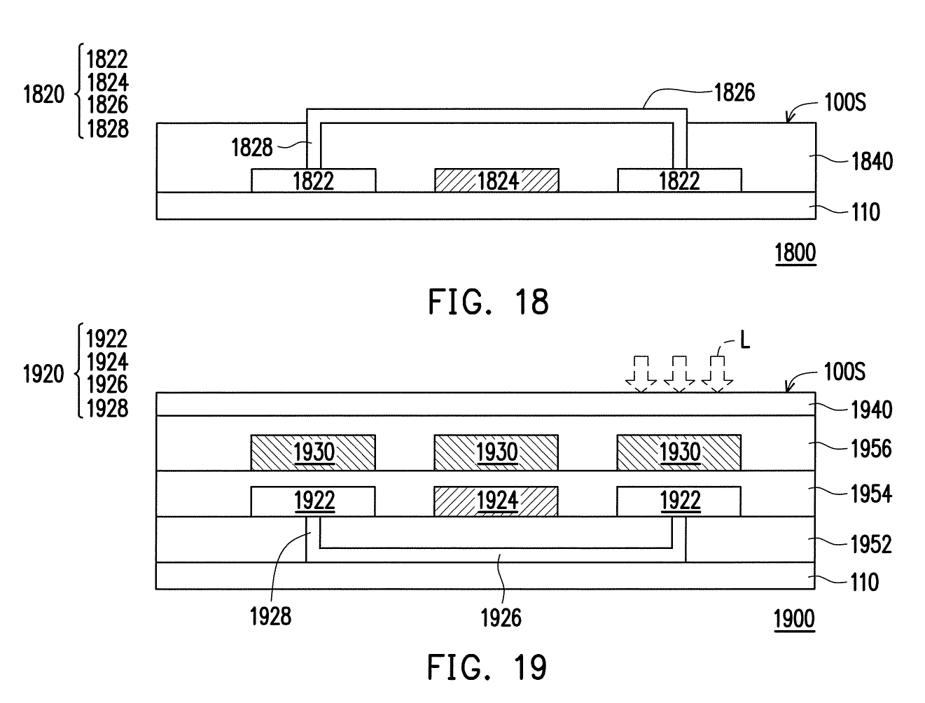

FIG. 18 is a schematic cross-sectional view illustrating a sensing panel 1800 according to an eighteenth embodiment of the disclosure, only some of the layers are illustrated in FIG. 18 for clarity of illustration. In FIG. 18, like or similar reference numerals represent like or similar components. Thus, components already described in FIG. 17 will not be described in the following. In this eighteenth embodiment, the sensing device layers 1820 includes at least one first filter conductive layer 1822 and at least one the second filter conductive layer 1824, and these first and second filter conductive layers are insulated from each other. A gray film 1840 is formed between the at least one first filter conductive layer 1822, the at least one second filter conductive layer 1824 and at least one sensing bridge 1826, and between the at least one first filter conductive layer 1822 and the at least one second filter conductive layer 1824. The gray film 1840 may be configured to separate the at least one first filter conductive layer 1822 from the at least one second filter conductive layer 1824, and separate the at least one first filter conductive layer 1822, the at least one second filter conductive layer 1824 and the at least one sensing bridge 1826 from one another. The at least one first filter conductive layer 1822 and the at least one second filter conductive layer 1824 of the sensing panel 1800 may correspond to positions between the sub-pixels of the display panel 20 to avoid light leakage, and also may locally shield the light reflected by the reflective layer 281 of the display panel 20. In the embodiment, the at least one first filter conductive layer 1822 and the at least one second filter conductive layer 1824 are conductive, thus in addition to receiving light, the at least one first filter conductive layer 1822 and the at least one second filter conductive layer 1824 may further transmit an electronic signal, for being adapted to sense an electrical change generated by the user's touch. Furthermore, an ambient light L entering the sensing panel 1800 from the sensing surface 100S becomes a transmitted light and does not generate reflection from irradiation to the sensing device layers 1820. Thus, images displayed by the display panel 20 and observed from outside through the sensing surface 100S of the sensing panel 1800 are not affected. Consequently, the display quality of the sensing display panel 10 may be reinforced. In an embodiment, the sensing bridge 1826 and conductive vias 1828 may be made of a conductive material having a filter property.

FIG. 19 is a schematic cross-sectional view illustrating a sensing panel 1900 according to a nineteenth embodiment of the disclosure. In FIG. 19, like or similar reference numerals represent like or similar components. Thus, components already described in FIG. 17 will not be described in the following. In this nineteenth embodiment, a sensing device layer 1920 further includes at least one sensing bridge 1926 and a plurality of conductive vias 1928, wherein at least one filter layer 1930 is located between the sensing device layer 1920 and a gray film 1940. The at least one sensing bridge 1926 is adjacent to one side of the first substrate 110, the conductive vias 1928 penetrate through a first dielectric layer 1952, and the first dielectric layer 1952 is located between the at least one sensing bridge 1926 and the at least one first conductive layer 1922 and the at least one second conductive layer 1924. In this embodiment, vias are formed in the first dielectric layer 1952 by etching, grind-drilling, laser drilling, or other suitable processes. Then, a conductive material is filled into the vias to form the conductive vias 1928 in the first dielectric layer 1952. Each of the at least one first conductive layer 1922 may connect to one of the sensing bridge 1926 on the first dielectric layer 1952 through a corresponding conductive via 1928. In one embodiment, the sensing panel 1900 may have a buffer layer (not shown) on the other side of the first substrate 110 with respect to the sensing device layer 1920, and the buffer layer may further include nanoparticles of metal or metal oxide, or carbon-based materials such as carbon powder, carbon-containing particles, or carbon black pigment, so that the buffer layer may absorb a part of the light and be provided as the gray film 1940. In an embodiment, an optical density ratio between the filter layer 1930 and the gray film 1940 with respect to visible light is N, and N may be greater than 1 and less than or equal to 40.

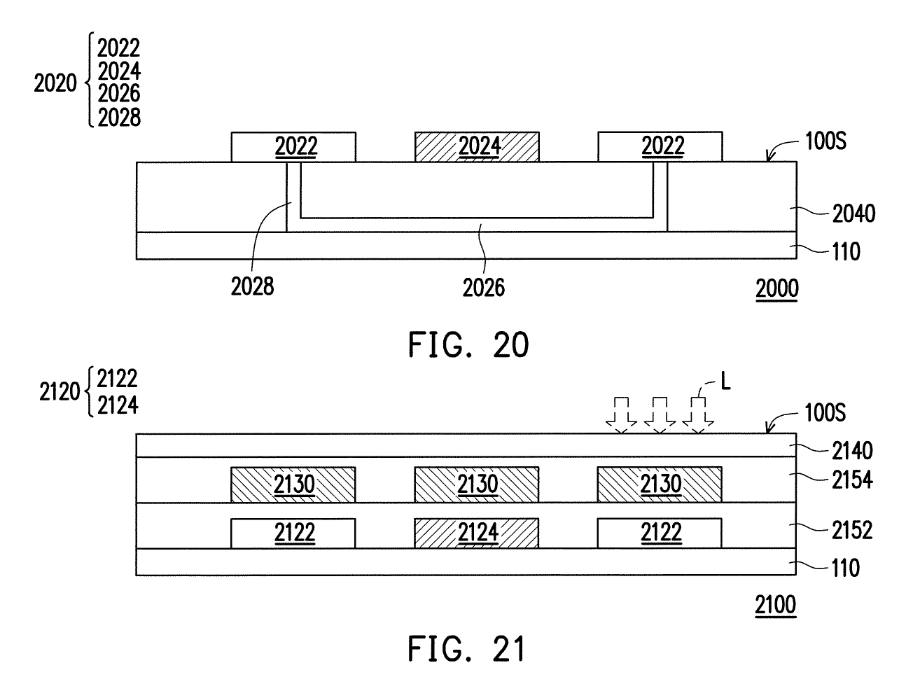

FIG. 20 is a schematic cross-sectional view illustrating a sensing panel 2000 according to a twentieth embodiment of the disclosure, only some of the layers are illustrated in FIG. 20 for clarity of illustration. In FIG. 20, like or similar reference numerals represent like or similar components. Thus, components already described in FIG. 19 will not be described in the following. In this twentieth embodiment, a sensing device layers 2020 includes at least one first filter conductive layer 2022 and at least one the second filter conductive layer 2024, and these first and second filter conductive layers are insulated from each other. A gray film 2040 is formed between the first filter conductive layer 2022, the second filter conductive layer 2024 and the sensing bridge 2026, and between the at least one first filter conductive layer 2022 and the at least one second filter conductive layer 2024. The gray film 2040 may be configured to separate the at least one first filter conductive layer 2022 from the at least one second filter conductive layer 2024, and separate the at least one first filter conductive layer 2022, the at least one second filter conductive layer 2024 and the at least one sensing bridge 2026 from one another. The at least one first filter conductive layer 2022 and the at least one second filter conductive layer 2024 of the sensing panel 2000 may correspond to positions between the sub-pixels of the display panel 20 to avoid light leakage, and also may locally shield the light reflected by the reflective layer 281 of the display panel 20. In this embodiment, the at least one first filter conductive layer 2022 and the at least one second filter conductive layer 2024 are conductive, thus in addition to receiving light, these first and second filter conductive layers may further transmit an electronic signal, for being adapted to sense an electrical change generated by the user's touch. Furthermore, an ambient light L entering the sensing panel 2000 from the sensing surface 100S becomes a transmitted light and does not generate reflection from irradiation to the sensing device layers 2020. Thus, images displayed by the display panel 20 and observed from outside through the sensing surface 100S of the sensing panel 2000 are not affected. Consequently, the display quality of the sensing display panel 10 may be reinforced. In an embodiment, the at least one sensing bridge 2026 and the conductive vias 2028 may be made of a conductive material having a filter property.

FIG. 21 is a schematic cross-sectional view illustrating a sensing panel 2100 according to a twenty-first embodiment of the disclosure. In FIG. 21, like or similar reference numerals represent like or similar components. Thus, components already described in FIG. 1 will not be described in the following. In this twenty-first embodiment, a sensing device layer 2120 includes at least one first conductive layer 2122 and at least one the second conductive layer 2124, and these first and second filter conductive layers are insulated from each other. The sensing device layer 2120 may be used to detect a signal generated by the user when the sensing display panel 10 is touched. A first dielectric layer 2152 is formed between each of the first conductive layers 2122 and the second conductive layer 2124; the first dielectric layer 2152 may be configured to separate each of the first conductive layer 2122 and the second conductive layer 2124 from each other. At least one filter layer 2130 is located between the gray film 2140 and the sensing device layer 2120. In one embodiment, a hardness of a gray film 2140 may be, for example, higher than 1 H to provide an anti-scratch function.

According to the aforesaid, in an embodiment, a sensing display panel of the present disclosure may include a display panel, a buffer layer, and a sensing panel. The display panel may include a first substrate and a reflective layer disposed on the first substrate. The buffer layer may have a first surface and a second surface opposite to the first surface, and the display panel may be disposed on the first surface. The sensing display may have a sensing surface disposed on the second surface of the buffer layer. The sensing display may include at least one filter layer, a gray film and a sensing device layer. Light transmitted from the sensing surface toward the sensing panel, the buffer layer, and the display panel may be reflected by the reflective layer. An optical density ratio between the gray film and the at least one filter layer with respect to visible light is N, and N may be greater than 1 and less than or equal to 40.

The sensing display panel according to disclosed embodiments may absorb light leakage from a sensing display panel and/or reflected ambient light by the filter layer and/or the gray film, to reduce the reflected light of the ambient light and/or the leaked light emitted from a sensing surface to improve the display quality. In the disclosed embodiments of the sensing display panel, the sensing panel and the display panel are bonded in the same direction to facilitate engagement. In addition, after the substrate of the sensing panel is removed, the sensing panel and the display panel may share the bonding area.

It will be clear that various modifications and variations can be made to the disclosure. It is intended that the specification and examples be considered as exemplary embodiments only, with a scope of the disclosure being indicated by the following claims and their equivalents.

What is claimed is:

1. A sensing display panel, comprising:
a display panel comprising a first substrate and a reflective layer, and the reflective layer disposed on the first substrate;
a buffer layer having a first surface and a second surface opposite to the first surface, wherein the display panel is disposed on the first surface;
a sensing panel disposed on the second surface of the buffer layer, wherein the sensing panel has a sensing surface and comprises at least one filter layer, a gray film, and a sensing device layer, a light transmitted from the sensing surface toward the sensing panel, the buffer layer, and the display panel is reflected by the reflective layer, wherein the sensing device layer comprises at least one first conductive layer and at least one second conductive layer, and the first and the second conductive layers are electrically insulated from each other; and
a plurality of first connection electrodes disposed on the second surface of the buffer layer or the first substrate of the display panel, wherein the plurality of first connection electrodes electrically connect to the at least one first conductive layer and the at least one second conductive layer, respectively.

2. The sensing display panel as claimed in claim 1, wherein the sensing panel further comprises a second substrate disposed between the buffer layer and the sensing device layer.

3. The sensing display panel as claimed in claim 1, wherein an optical density ratio between the at least one filter layer and the gray film with respect to a visible light is N, and N is greater than 1 and less than or equal to 40.

4. The sensing display panel as claimed in claim 1, wherein the gray film is located on the sensing device layer, and the at least one filter layer is located between the sensing device layer and the gray film.

5. The sensing display panel as claimed in claim 1, wherein the at least one filter layer is located on the sensing device layer, and the gray film is located between the sensing device layer and the at least one filter layer.

6. The sensing display panel as claimed in claim 1, wherein the gray film is located between the at least one first conductive layer and the at least one second conductive layer.

7. The sensing display panel as claimed in claim 1, wherein the sensing device layer is located between the gray film and the at least one filter layer.

8. The sensing display panel as claimed in claim 1, further comprising a dielectric layer, wherein the dielectric layer covers the at least one filter layer or the at least one second conductive layer, or covers both the at least one filter layer and the at least one second conductive layer.

9. The sensing display panel as claimed in claim 1, wherein the at least one second conductive layer is in contact with the at least one filter layer.

10. The sensing display panel as claimed in claim 1, wherein the at least one second conductive layer is located between the at least one first conductive layer and the at least one filter layer, and the at least one second conductive layer and at least one filter layer are separated from each other.

11. The sensing display panel as claimed in claim 1, wherein the sensing device layer further comprises a plurality of conductive vias and at least one sensing bridge, the plurality of conductive vias are located between the at least one first conductive layer and the at least one sensing bridge, and the at least one first conductive layer electrically connects to the at least one sensing bridge through the plurality of conductive vias.

12. The sensing display panel as claimed in claim 1, wherein the sensing panel further comprises a second substrate disposed between the buffer layer and the gray film.

13. The sensing display panel as claimed in claim 1, wherein the gray film is in contact with the buffer layer.

14. The sensing display panel as claimed in claim 1, wherein the display panel further comprises at least one first electrode, a second electrode, and a plurality of second connection electrodes, wherein the at least one first electrode, the second electrode, and the plurality of second connection electrodes are disposed on the first substrate, and the plurality of second connection electrodes are in contact with the first substrate and electrically connect to the at least one first electrode and the second electrode, respectively.

15. A sensing display panel, comprising:
a display panel comprising a first substrate and a reflective layer disposed on the first substrate;
a buffer layer having a first surface and a second surface opposite to the first surface, wherein the display panel is disposed on the first surface; and
a sensing panel disposed on the second surface of the buffer layer, wherein the sensing panel has a sensing surface and comprises at least one filter layer and a sensing device layer, a light transmitted from the sensing surface toward the sensing panel, the buffer layer, and the display panel is reflected by the reflective layer, an optical density ratio between the buffer layer and the at least one filter layer with respect to a visible light is N, and N is greater than 1 and less than or equal to 40.

16. The sensing display panel as claimed in claim 15, wherein the sensing panel further comprises a second substrate disposed between the buffer layer and the sensing device layer.

17. The sensing display panel as claimed in claim 15, wherein the sensing device layer is located between the buffer layer and the at least one filter layer.

18. The sensing display panel as claimed in claim 15, wherein the sensing device layer comprises a plurality of conductive layers electrically insulated from one another, a plurality of conductive vias, and at least one sensing bridge, the plurality of conductive vias are located between the plurality of conductive layers and the at least one sensing bridge, and a part of the plurality of conductive layers respectively electrically connect to the at least one sensing bridge through the plurality of conductive vias.

19. The sensing display panel as claimed in claim 15, further comprising a plurality of first connection electrodes, wherein the plurality of first connection electrodes are disposed on the second surface of the buffer layer or the first substrate of the display panel, and electrically connect to the sensing device layer.

20. The sensing display panel as claimed in claim 19, wherein the display panel further comprises at least one first electrode, a second electrode, and a plurality of second connection electrodes, wherein the at least one first electrode, the second electrode, and the plurality of second connection electrodes are disposed on the first substrate, the plurality of second connection electrodes are in contact with the first substrate and electrically connect to the at least one first electrode and the second electrode, respectively.
